(19) United States
(12) Patent Application Publication
(10) Pub. No.: US 2010/0066866 A1
(43) Pub. Date: Mar. 18, 2010

(54) APPARATUS AND METHOD FOR REDUCING POPPING ARTIFACTS FOR MULTI-LEVEL LEVEL-OF-DETAIL TERRAINS

(75) Inventor: Choong Gyoo Lim, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejon (KR)

(21) Appl. No.: 12/517,190

(22) PCT Filed: Nov. 27, 2007
(86) PCT No.: PCT/KR2007/006020

§ 371 Date: Jun. 1, 2009

(30) Foreign Application Priority Data
Dec. 2, 2006 (KR) 10-2006-0121088
Aug. 30, 2007 (KR) 10-2007-0087513

(51) Int. Cl. H04N 5/228

(52) U.S. Cl. 348/241; 348/E05.022

(57) ABSTRACT

Provided are an apparatus and method for reducing the popping artifacts of level-of-detail terrain images. The apparatus includes a terrain patch constructor, a level-of-detail deciding unit, a controller, and a tapering unit. The terrain patch constructor forms terrain patches from multi-level level-of-detail patches. The level-of-detail deciding unit receives the generated terrain patches from the terrain patch constructor and decides a level-of-detail for each of the received terrain patches according to the camera distance. The controller determines whether adjacent terrain patches exist or not. The tapering unit receives terrain patches together with neighboring patches of adjacent level-of-detail from the level-of-detail deciding unit in response to the control of the controller and smoothly connects two terrain patches by applying the tapering technique.

### TECHNICAL FIELD

The present invention relates to a method for reducing popping artifacts for level-of-detail terrain images; more particularly, to a method for reducing popping artifacts that are created while large scale terrain data is expressed in multi-level level-of-detail in realtime.

This work was partly supported by the Information Technology (IT) research and development program of the Korean Ministry of Information and Communication (MIC) and/or the Korean Institute for Information Technology Advancement (IITA) [2006-S-044-01, “multi-core CPU and MPU based cross platform game technology”].

### BACKGROUND ART

In general, Geomorph or Q-morph has been widely used for preventing popping artifacts in the fields of computer graphics, virtual reality, and geographical information system (GIS).

The Geomorph technology was disclosed in U.S. Pat. No. 6,426,750 issued to Microsoft Corporation and entitled “Run-time geomorphs”. In the run-time Geomorph, an order of adding or removing vertices of a three-dimensional (3-D) mesh is previously calculated, and the vertices are added or removed according to a desired level-of-detail when rendering is performed. That is, the run-time Geomorph relates to a technology for reducing popping artifacts by smoothly connecting meshes having different levels-of-detail according to the value of the time variable of each frame. That is, the run-time geomorphs technology generates a 3-D mesh model having multi-level level-of-detail in real time while minimizing popping artifacts.

However, the run-time Geomorph technology incurs large system overhead because it is necessary to draw same meshes in a few different levels-of-details.

Therefore, it is necessary to develop a method for minimizing popping artifacts without increasing the system overhead.

Meanwhile, the related technology of the Q-morph was introduced in an article by Cline et. al, entitled “Terrain Decimation through Quadtree Morphing” in IEEE Transactions on Visualization and Computer Graphics, Vol. 7, No. 1, 62-69, 1997. In the related technology of the Q-morph, popping artifacts are reduced by calculating the camera distances of each vertex, calculating weights of each vertex based on the calculated camera distances of each vertex, and blending two terrain images at all pixels of a patch.

In the related technology of the Q-morph, if camera setting does change, it is necessary to perform a blending operation, thus incurring some system overhead. Therefore, it needs to minimize the overhead.

### DISCLOSURE

### Technical Problem

An embodiment of the present invention is directed to providing a method for effectively minimizing popping artifacts of multi-level level-of-detail terrains using an alpha blending function of graphics hardware and a previously constructed alpha texture for blending while generating very small overhead of a graphics system.

### Technical Solution

In accordance with an aspect of the present invention, there is provided an apparatus for reducing popping artifacts for multi-level level-of-detail terrain images, including a terrain patch constructor, a level-of-detail deciding unit, a controller, and a tapering unit. The terrain patch constructor forms terrain patches by applying the height information onto multi-level level-of-detail patch. The level-of-detail deciding unit receives the generated terrain patches from the terrain patch constructor and decides a level-of-detail for each of the received terrain patches according to a camera distance. The controller determines whether adjacent terrain patches exist or not. The tapering unit receives terrain patches having adjacent level-of-detail from the level-of-detail deciding unit in response to the control of the controller and smoothly connects two terrain patches by applying a tapering technique.

In accordance with another aspect of the present invention, there is provided a method for reducing popping artifacts of multi-level level-of-detail terrain images, including the steps of: at a terrain patch constructor, forming terrain patches by applying information about heights of terrains to patches having multilevel level-of-detail; at a level-of-detail deciding unit, deciding a level-of-detail for each terrain patch according to a camera distance; and at a tapering unit, smoothly connecting two terrain patches having adjacent level-of-detail by applying a tapering technique.

### ADVANTAGEOUS EFFECTS

An apparatus and method for reducing popping artifacts of level-of-detail terrain images according to the present invention minimizes popping artifacts that are created at multi-level level-of-detail terrain images which are used in a computer game and a virtual reality system that express large scale terrain data in real time.

First of all, the apparatus and method according to the present invention can reduce overhead for blending because a coordinate value (u,v) is decided according to a camera distance.

Secondly, the apparatus and method according to the present invention can reduce popping artifacts of terrain images without additionally generated overhead using the alpha blending function of graphics hardwares.

Thirdly, the apparatus and method according to the present invention can smoothly connect terrain images of different level-of-detail by changing the distribution of alpha values in the previously created alpha texture.

### BRIEF DESCRIPTION OF THE DRAWINGS

FIG. 1 is a block diagram illustrating an apparatus for reducing popping artifacts for multi-level level-of-detail terrain images according to an embodiment of the present invention.

FIG. 2 is a flowchart illustrating a method for reducing the popping artifacts for multi-level level-of-detail terrain images according to an embodiment of the present invention.

FIG. 3 is a flowchart illustrating a procedure of connecting terrain patches in the method of FIG. 2.

FIG. 4 is a diagram illustrating a sample layout of terrain patches in multi-level level-of-detail terrain images according to an embodiment of the present invention.

FIG. 5 is a diagram illustrating some alpha textures to be used for blending terrain images according to an embodiment of the present invention.

FIG. 6 is a diagram illustrating the sample layout of terrain patches with the alpha blending applied upon according to an embodiment of the present invention.

FIG. 7 is a diagram illustrating a result terrain image according to an embodiment of the present invention.

### BEST MODE FOR THE INVENTION

The advantages, features and aspects of the invention will become apparent from the following description of the embodiments with reference to the accompanying drawings, which is set forth hereinafter.

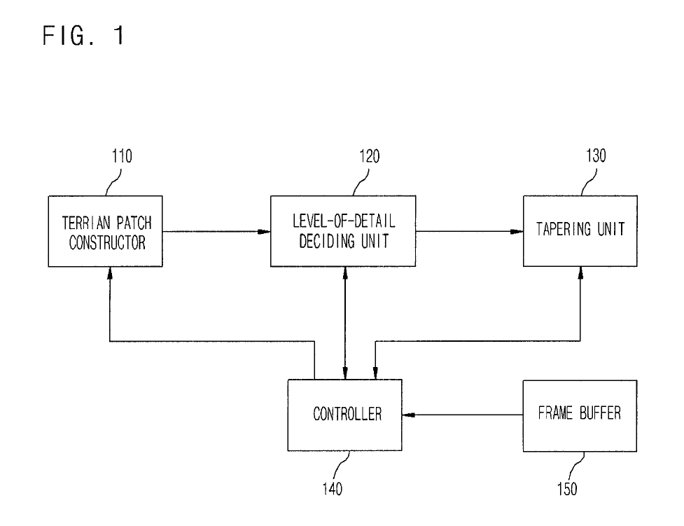

FIG. 1 is a block diagram illustrating an apparatus for reducing the popping artifacts of multi-level level-of-detail terrain images according to an embodiment of the present invention.

Referring to FIG. 1, the apparatus according to the present embodiment includes a terrain patch constructor 110, a level-of-detail deciding unit 120, a tapering unit 130, a controller 140, and a frame buffer 150.

At first, the terrain patch constructor 110 forms terrain patches from multi-level level-of-detail patches.

The level-of-detail deciding unit 120 receives the generated terrain patches from the terrain patch constructor 110 and decides a level-of-detail for each terrain patch.

The controller 140 identifies terrain patches having neighboring patches of adjacent level-of-detail. If a adjacent patch exists, the controller 140 controls the level-of-detail deciding unit 120 to transmit such terrain patches with neighboring patches of adjacent level-of-detail to the tapering unit 130.

Adjacent terrain patches mean that textures or meshes of different level-of-details are adjacent.

The tapering unit 130 receives the terrain patches having adjacent level-of-detail from the level-of-detail deciding unit 120 and smoothly connects the two terrain patches using the tapering technique. Here, the tapering unit 130 performs an alpha blending operation to blend terrain patches of adjacent level-of-detail (i+1 level or i level) using an alpha value stored in the frame buffer 150.

In order to perform the alpha-blending operation, an alpha texture is used to blend. Here, a coordinate (u,v) for applying the alpha texture is calculated based on the distance from each vertex of a patch to a camera. In order to quickly calculate the coordinate (u,v), the difference value between the coordinates of the camera and the coordinates of a vertex are utilized. For example, the coordinate (u,v) can be quickly calculated using u=Xv−Xc, and v=Zv−Zc. Here, Xv is an X-axis coordinate of a vertex, Xc denotes a X-axis coordinate of the camera, Zv denotes a Z-axis coordinate of a vertex, and Zc is a Z-axis coordinate of the camera.

In order to accurately calculate the (u,v) coordinate, the different vector Vdiff of a camera coordinate and a vertex coordinate in a corresponding plane is used. That is, Eq. 1 is used to calculate (u,v) value.

u=sign (Vdiff.x)*size((Vdiff.x,Vdiff.y,0))

v=sign (Vdiff.z)*size((0,Vdiff.y,Vdiff.z). Eq. 1.

After the coordinate (u, v) is calculated based on Eq. 1, the first patch is drawn with a basic texture at the i or an i+1 level-of-detail. Then, the second patch is drawn using the alpha texture and the calculated coordinate (u, v).

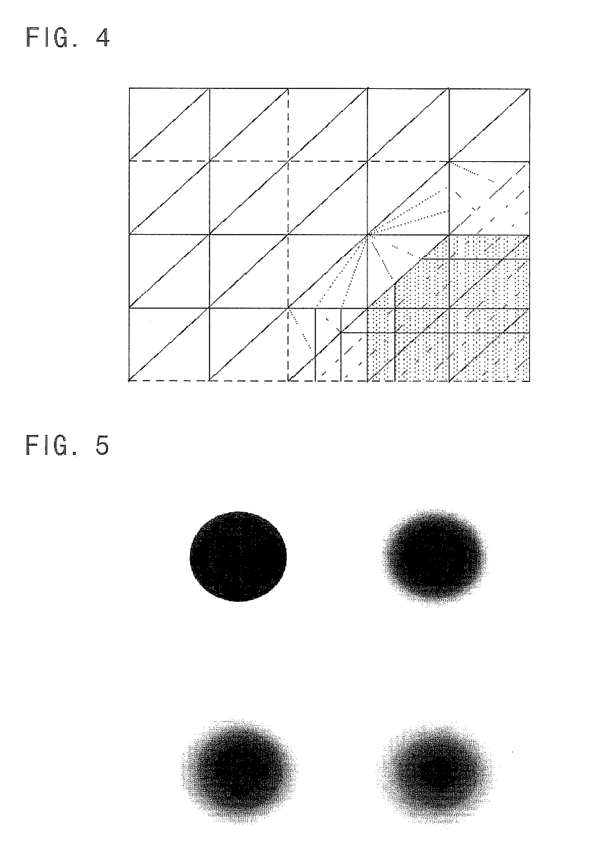

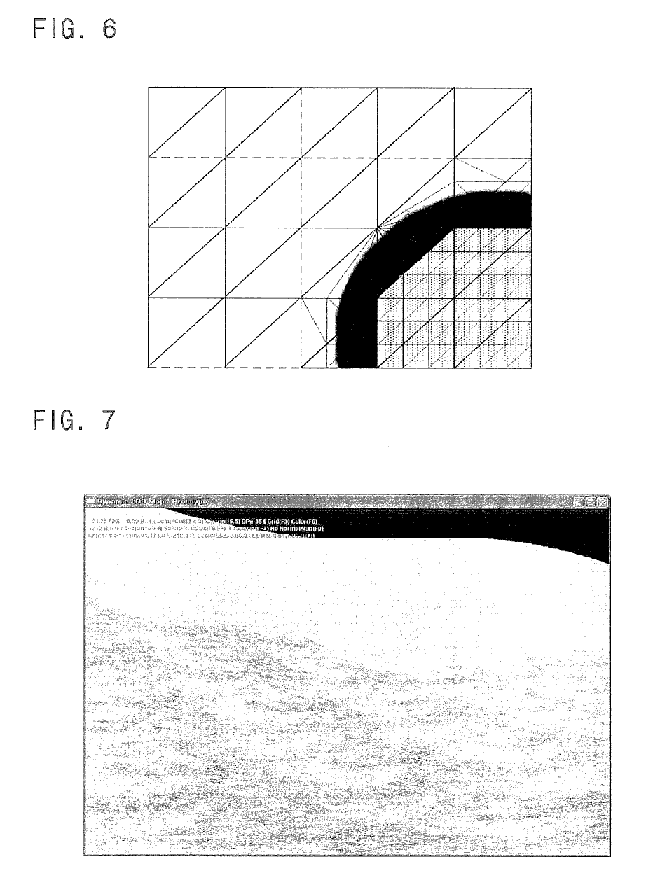

Meanwhile, FIG. 4 is a diagram illustrating a sample layout of terrain patches in multi-level level-of-detail terrains according to an embodiment of the present invention, FIG. 5 is a diagram illustrating some alpha textures to be used for blending terrain images according to an embodiment of the present invention, and FIG. 6 is a diagram illustrating the sample layout of terrain patches with the alpha blending applied upon according to an embodiment of the present invention. Therefore, if FIGS. 4 and 5 are applied, an image with the alpha texture applied by applying the alpha value of a frame buffer can be obtained as shown in FIG. 6.

As shown in FIG. 6, the terrain patches are expressed at the i+1 level-of-detail or the i level-of-detail using the alpha textures stored in the frame buffer 150. FIG. 7 is a result terrain image according to an embodiment of the present invention. As shown in FIG. 7, the terrain patches with different level-of-detail are smoothly connected to each other.

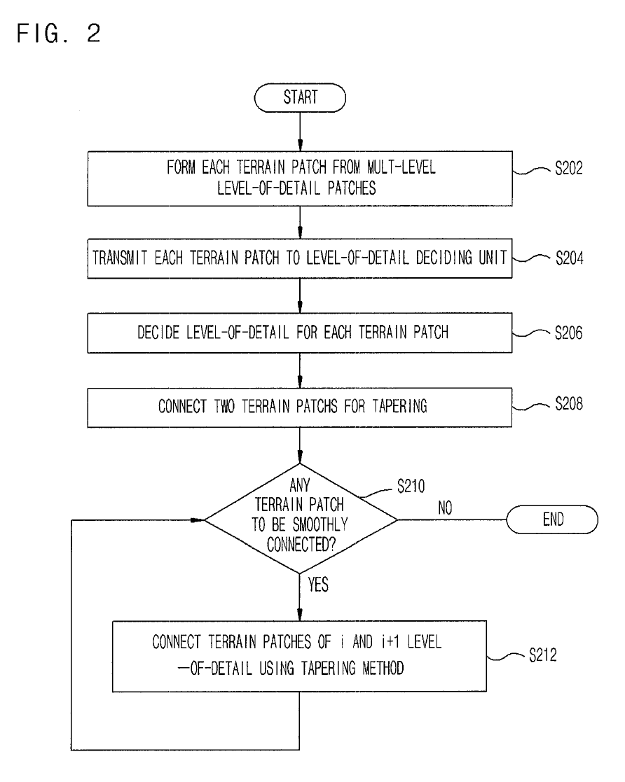

FIG. 2 is a flowchart illustrating a method for reducing the popping artifacts of multi-level level-of-detail terrain images according to an embodiment of the present invention.

Referring to FIG. 2, the terrain patch constructor 110 forms terrain patches by applying information about the heights of terrains to patches having multi-level level-of-detail at step S202.

The terrain patch constructor 110 transmits the generated terrain patches to the level-of-detail deciding unit 120 at step S204.

The level-of-detail deciding unit 120 decides a level-of-detain for each terrain patch according to the camera distance at step S206.

The level-of-detail deciding unit 120 transmits terrain patches with neighboring patches of adjacent level-of-details to the tapering unit 130. The tapering unit 130 connects the transmitted adjacent terrain patches to each others at step S208.

The controller 140 determines whether any terrain patches remain to be smoothly connected or not at step S210 of which the level-of-detail were determined by the level-of-detail deciding unit 120.

If any patches remain to be connected at step S210, the controller 140 controls the level-of-detail deciding unit 120 to transmit a terrain patch of an adjacent level-of-detail to the tapering unit 130. The tapering unit 130 receives terrain patches having neighboring patches of adjacent level-of-details and smoothly connects such terrain patches by applying a tapering technique at step S212.

If no patch remains to be connected at step S210, the controller 140 determines that no patches are left to be connected and terminates the method thereof.

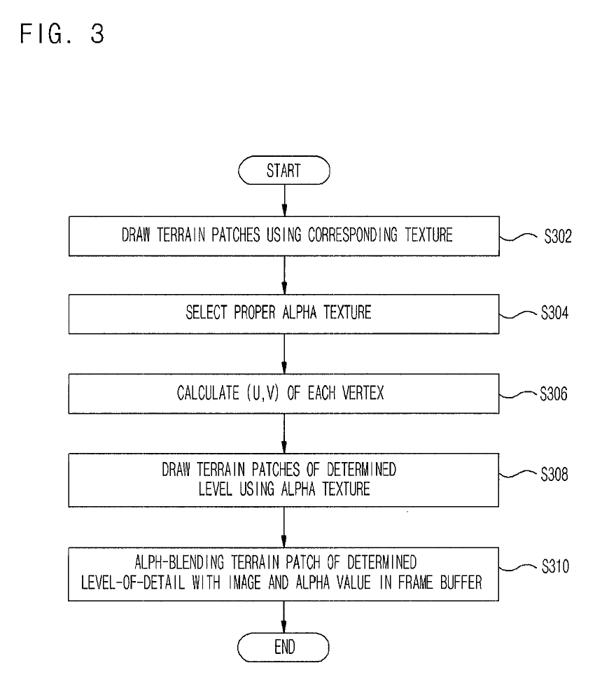

FIG. 3 is a flowchart illustrating a procedure of connecting terrain patches in the method of FIG. 2.

Referring to FIG. 3, a corresponding terrain patch with an i level or (i+1) level-of-detail is drawn using a corresponding texture at step S302.

A predetermined alpha texture is selected from a plurality of prepared alpha textures according to a smooth connecting level at step S304.

Then, a coordinate (u,v) of each vertex is calculated to apply an alpha texture to a patch at step S306.

The terrain patch having an i+1 or i level-of-detail is drawn using the alpha texture for an alpha blending operation at step S308.

Then, a final image is composed by performing an alpha-blending operation for blending the terrain patch having an i+1 or i level-of-detail with images in a frame buffer using an alpha value stored in a frame buffer at step S310.

In the present embodiment, the alpha texture is composed in advance and used for blending two terrain images.

The alpha value of the alpha texture decides a weight of each terrain image to form the value of each pixel in the resulting terrain image. A user may change such a weight according to level-of-detail, brightness, and color texture of an image.

While the present invention has been described with respect to certain preferred embodiments, it will be apparent to those skilled in the art that various changes and modifications may be made without departing from the scope of the invention as defined in the following claims.

1. An apparatus for reducing popping artifacts for multi-level level-of-detail terrain images, comprising:
a terrain patch constructor for forming terrain patches from multi-level level-of-detail patches;
a level-of-detail deciding unit for receiving the generated terrain patches from the terrain patch constructor and deciding a level-of-detail for each of the received terrain patches according to the camera distance;
a controller for determining whether adjacent terrain patches exist or not; and
a tapering unit for receiving terrain patches with neighboring patches of adjacent level-of-detail from the level-of-detail deciding unit in response to the control of the controller and smoothly connects two terrain patches by applying a tapering technique.

2. The apparatus of claim 1, wherein the tapering technique is alpha blending.

3. The apparatus of claim 2, wherein the alpha blending uses an alpha texture to blend, and a coordinate (u,v) for applying the alpha texture is calculated using the difference between the camera coordinate and a vertex coordinate.

4. The apparatus of claim 2, wherein the alpha blending uses an alpha texture to blend, and a coordinate (u,v) for applying the alpha texture is calculated using the difference vector between the camera coordinate and a vertex coordinate on a corresponding plane.

5. The apparatus of claim 4, wherein the difference vector of a distance between the camera and a vertex on a corresponding plane is calculated using the following equation:
u=sign(Vdiff.x)*size((Vdiff.x,Vdiff.y,0))
v=sign(Vdiff.z)*size((O,Vdiff.y,Vdiff.z),
where Vdiff.x denotes the difference vector between the camera and a vertex on the x-axis,
Vdiff.y denotes the difference vector between the camera and a vertex on the y-axis, and
Vdiff.z is the difference vector between the camera and a vertex on a z-axis.

6. A method for reducing popping artifacts for multi-level level-of-detail terrain images, comprising the steps of:
at a terrain patch constructor, forming terrain patches by applying information about heights of terrains to patches having multi-level level-of-detail;
at a level-of-detail deciding unit, deciding a level-of-detail for each terrain patch according to the camera distance; and
at a tapering unit, smoothly connecting two terrain patches having adjacent level-of-detail by applying the tapering technique.

7. The method of claim 6, further comprising the steps of:
after deciding the level-of-detail for each terrain patch, determining whether any adjacent patch to be connected exists or not; and
transmitting terrain patches having adjacent level-of-detail to the tapering unit if a terrain patch to be connected exists.

8. The method of claim 6, wherein the smoothly connecting of two terrain patches includes the steps of:
drawing a terrain patch having a predetermined level-of-detail using a corresponding texture;
selecting a predetermined alpha texture according to a smooth level of connecting among the prepared alpha textures;
calculating a (u,v) coordinate of each vertex for applying an alpha texture to the terrain patch;
drawing a terrain patch of a predetermined level-of-detail by using the alpha texture to the terrain patch; and
performing an alpha blending operation for blending a terrain patch of a predetermined level-of-detail with the image of the frame buffer by using alpha values in the frame buffer.

9. The method of claim 7, wherein the smoothly connecting of two terrain patches includes the steps of:
drawing a terrain patch having a predetermined level-of-detail using a corresponding texture;
selecting a predetermined alpha texture according to a smooth level of connecting among the prepared alpha textures;
calculating a (u,v) coordinate of each vertex for applying an alpha texture to the terrain patch;
drawing a terrain patch of a predetermined level-of-detail by using the alpha texture to the terrain patch; and
performing an alpha blending operation for blending a terrain patch of a predetermined level-of-detail with the image of the frame buffer by using alpha values in the frame buffer.
